(19) United States
(12) Patent Application Publication
(10) Pub. No.: US 2003/0227579 A1
(43) Pub. Date: Dec. 11, 2003

(54) Liquid crystal display

(75) Inventors: Tadaki Nakahori, Kumamoto (JP); Makoto Ootani, Kumamoto (JP)

Correspondence Address: McDERMOTT, WILL & EMERY, 600 13th Street, N.W., Washington, DC, 20005-3096, US

(73) Assignee: KABUSHIKI KAISHA ADVANCED DISPLAY

(21) Appl. No.: 10/394,270

(22) Filed: Mar. 24, 2003

(30) Foreign Application Priority Data
Jun. 10, 2002 (JP) P2002-168956

(51) Int. Cl. G02F 1/136

(52) U.S. Cl. 349/43

(57) ABSTRACT

A highly reliable liquid crystal display is obtained at a high yield rate by preventing disconnection of upper wiring (signal line) due to level difference due to lower wiring (scan line) in a region where the wirings (scan line and signal line) are intersected via an insulating film or the like in a TFT array substrate in which the TFT acting as a switching element is arrayed and formed into a matrix. A scan line (gate wiring) 2 has a pattern of including at least one bend 8a on both sides of the pattern in a region where the scan line (gate wiring) 2 and the signal line (source wiring) 6 are intersected.

### BACKGROUND OF THE INVENTION

1. Field of the Invention

The present invention relates to an active matrix liquid crystal display onto which a thin-film transistor (hereinafter referred to as TFT) is mounted to act as a switching element.

2. Description of the Related Art

In an active matrix liquid crystal display, a liquid crystal is sandwiched between a TFT array substrate, in which a TFT is disposed forming a matrix to act as a switching element on a transparent insulating substrate such as glass substrate, and a color filter substrate including opposed electrodes. Commercialization of this active matrix liquid crystal display has gone ahead to serve as a flat display with expectation of flattening an image display, and an intensive marketing of the active matrix liquid crystal display is under development for use in OA monitors including a note-type personal computer.

In the TFT, which is mounted on an active matrix liquid crystal display to act as a switching element, amorphous silicon capable of being deposited in a large area at a relatively low temperature is utilized as a semiconductor layer in most cases.

One example of a manufacturing method of a conventional TFT array substrate is now described referring to the drawings.

FIG. 6 is a cross sectional view showing an essential part of the conventional TFT array substrate. Reference numeral 1 designates a glass substrate, numeral 2 designates a gate wiring (including a gate electrode part), and numeral 3 designates a gate insulating film. Numeral 4 designates a semiconductor layer, and numeral 5 designates an ohmic contact layer. Numeral 6 designates a source wiring (including a source electrode part), and numeral 7 designates a drain electrode. Numeral 9 designates a passivation film, numeral 10 designates a picture electrode, and numeral 11 designates a contact hole.

Firstly, a first conductive thin film, which is made of Cr, Mo or the like, is formed on the glass substrate 1, and thereafter the first conductive thin film is patterned by a first photomechanical process to form the gate wiring 2 and a retention volume electrode (not shown).

Subsequently, a gate insulting film 3, a—si:H (amorphous silicon to which a hydrogen atom is added) film, and n⁺a—Si:H film are continuously laminated by plasma CVD method. Thereafter, the a—Si:H film and the n⁺a—Si:H film are patterned by a second photomechanical process to form the semiconductor layer 4 and the ohmic contact layer 5 over the gate wiring 2 (gate electrode part).

Next, the second conductive thin-film, which is made of Cr, Mo or the like, is formed, and thereafter this second conductive thin-film is patterned by a third photomechanical process to form the source wiring 6 and the drain electrode 7. Subsequently, the ohmic contact layer 5 in a channel region is etched using the formed source wiring 6 and the drain electrode 7 as masks thereby forming a TFT.

Then, the passivation film 9 is laminated by a plasma CVD method, and thereafter the contact hole 11 is formed in the passivation film 9 by a fourth photomechanical process.

Finally, a third conductive thin-film, which is made of ITO or the like, is formed, and thereafter the third conductive thin-film is patterned by a fifth photomechanical process to form the picture electrode 10. At this time, the picture electrode 10 is electrically connected to the drain electrode 7 via the contact hole 11. The mentioned steps form a TFT array.

However, several problems exist in the conventional TFT array substrate formed by the steps as mentioned above. That is, in the steps of forming the second conductive thin-film by sputtering or the like, forming a resist pattern by the third photomechanical process, etching the second conductive thin-film by wet etching to form the source wiring 6 and the drain electrode 7, as shown in FIG. 7 (b), a level difference portion due to the gate wiring 2 comes to form an eaves shape in conformity with configuration of an end face of the gate wiring 2 in a region where the gate wiring 2 and the source wiring 6 are intersected. Therefore, a problem exist in that the second conductive thin-film (source wiring 6) formed on the eaves-shaped level difference portion occasionally does not fit well at the level difference portion, and adheres insufficiently to the lower layers resulting in occurrence of a gap 12; and accordingly an etchant for etching the second conductive thin-film erodes in the direction indicated by the arrows in FIG. 7(a). Consequently, the etchant leaks into under part of the second conductive thin-film at the portion (such as gap 12) where adhesion of the second conductive thin-film (source wiring 6) to the lower layer is insufficient and generate disconnection of the source wiring 6 eventually resulting in a faulty display.

In addition, FIG. 7(a) is a planer view, and FIG. 7(b) is a cross sectional view taken along the line B-B of FIG. 7(a).

### SUMMARY OF THE INVENTION

The present invention was made to solve the above-discussed problems, and has an object of obtaining a highly reliable liquid crystal display at a high yield rate by preventing occurrence of fault such as disconnection at an upper layer wiring (source wiring) in a region where the wirings are intersected via insulating film, etc.

A liquid crystal display according to the invention includes a plurality of scan lines formed on a transparent insulating substrate; a plurality of signal lines formed in a direction of intersecting with this scan line via an insulating layer; and a switching element that is supplied with signals from the scan lines and the signal lines, and applies voltage to a display electrode. The mentioned liquid crystal display is characterized in that the scan lines have at least one bend on both sides of a pattern in a region where the scan lines intersect with the signal lines.

As a result, a highly reliable liquid crystal display can be obtained at a high yield rate by preventing disconnection of any signal line due to a level difference brought by the scan lines.

### BRIEF DESCRIPTION OF THE DRAWINGS

FIG. 1 is a plan view schematically showing an essential part in the process of manufacturing a TFT array substrate constituting a liquid crystal display according to a first preferred embodiment of the present invention.

FIG. 2 is a plan view schematically showing an essential part in the process of manufacturing a TFT array substrate constituting a liquid crystal display according to a second embodiment of the invention.

FIG. 3 is a plan view schematically showing an essential part in the process of manufacturing a TFT array substrate constituting another liquid crystal display according to the second embodiment of the invention.

FIG. 4 is a plan view schematically showing an essential part in the process of manufacturing a TFT array substrate constituting a liquid crystal display according to a third embodiment of the invention.

FIG. 5 is a plan view schematically showing an essential part in the process of manufacturing a TFT array substrate constituting another liquid crystal display according to the third embodiment of the invention.

FIG. 6 is a cross sectional view showing an essential part of a TFT array constituting a liquid crystal display of this type according to the prior art.

FIGS. 7 (a) and (b) are views for explaining problems incidental to the TFT array substrate constituting the liquid crystal display according to the prior art.

### DESCRIPTION OF THE PREFERRED EMBODIMENTS

Embodiment 1.

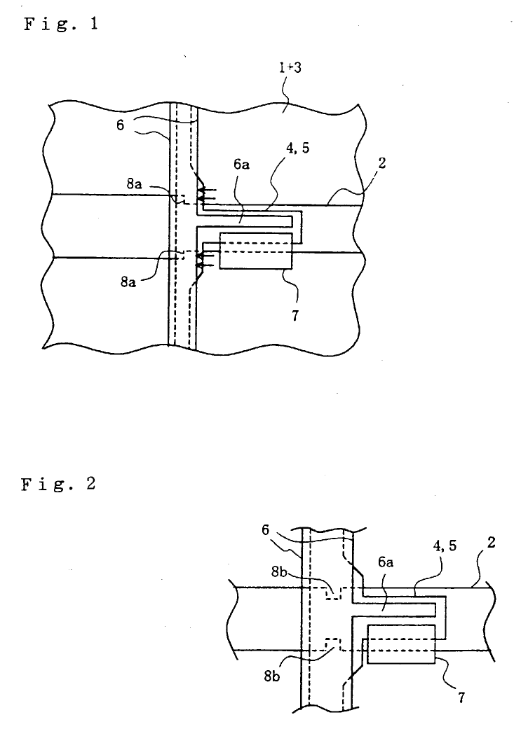

A liquid crystal display, which is one of the preferred embodiments according to the present invention, is described hereinafter referring to the drawings. FIG. 1 is a plan view schematically showing an essential part in the process of manufacturing a TFT array substrate constituting a liquid crystal display according to a first embodiment of the invention.

Referring now to FIG. 1, reference numeral 1 designates a glass substrate, numeral 2 designates a scan line (gate wiring, including a gate electrode part), and numeral 3 designates a gate insulating film. Numeral 4 designates a semiconductor layer, and numeral 5 designates an ohmic contact layer. Numeral 6 designates signal lines (source wiring), and numeral 6a designates a source electrode. Numeral 7 designates a drain electrode, and numeral 8a designates a bend provided respectively on both sides of a pattern of the gate wiring 2.

Now a manufacturing process of the TFT array substrate of the liquid crystal display according to this embodiment is hereinafter described.

Firstly, a first conductive thin-film, which is made of Cr, Mo or the like, is formed on the glass substrate 1, and thereafter the first conductive thin-film is patterned by a first photomechanical process to form the gate wiring 2 and a retention volume electrode (not shown). At this time, the gate wiring 2 has at least one bend 8a respectively on both sides of the pattern in a region where the gate wiring 2 intersects with the source wiring 6 to be formed later. In the case of providing a plurality of bends, they will be stepwise.

Subsequently, the gate insulating film 3, a—Si:H (amorphous silicon to which a hydrogen atom is added) film, and n⁺a—Si:H film are continuously laminated by a plasma CVD method, and thereafter the a—Si:H film and n⁺a—Si:H film are patterned by a second photomechanical process to form the semiconductor layer 4 and the ohmic contact layer 5 over the gate electrode 2 (gate electrode part).

Then, a second conductive thin-film, which is made of Cr, Mo or the like, is formed, and thereafter the second conductive thin-film is patterned by a third photomechanical process to form the source wiring 6, the source electrode 6a and the drain electrode 7 (FIG. 1).

Next, the ohmic contact layer 5 in channel region is etched using the formed source electrode 6a and the drain electrode 7 as masks thereby forming a TFT.

Then, a passivation film is laminated by plasma CVD method, and thereafter a contact hole is formed in the passivation film by a fourth photomechanical process.

Finally a third conductive film, which is made of ITO or the like, is formed, and thereafter the third conductive thin-film is patterned by a fifth photomechanical process to form a picture electrode. At this time, the picture electrode is electrically connected to the drain electrode 7 via the contact hole. The mentioned steps form a TFT array substrate.

In this first embodiment, when the second conductive thin-film is formed, then a resist pattern is formed by the third photomechanical process and the second conductive thin-film is etched by a wet etching to form the source wiring 6, the source electrode 6a and the drain electrode 7, the problem of disconnection of the source wiring 6 in the region where the gate wiring 2 and the source wiring 6 are intersected can be successfully prevented in the following manner. That is, in this region, in the case where the second conductive thin-film does not fit well and adheres insufficiently to the lower layer at a level difference portion conforming to the configuration of the level difference portion of the gate wiring 2, it is certain that an etchant, which etches the second conductive thin-film, erodes in a direction indicated by the arrows in FIG. 1. But, leaking of the ethcant into under part of the second conductive thin-film is blocked with the bends 8a provided at the gate wiring 2, thereby enabling to prevent disconnection of the source wiring 6 at the intersection portion between the gate wiring 2 and the source wiring 6.

Embodiment 2.

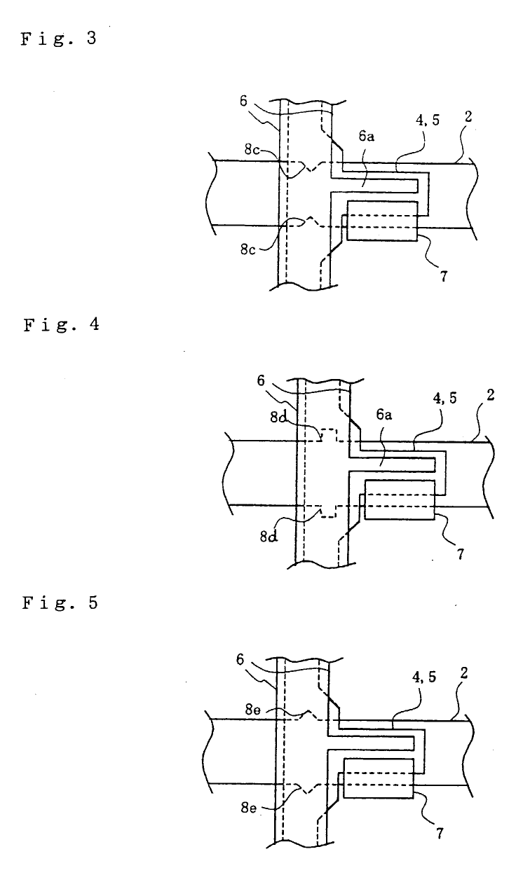

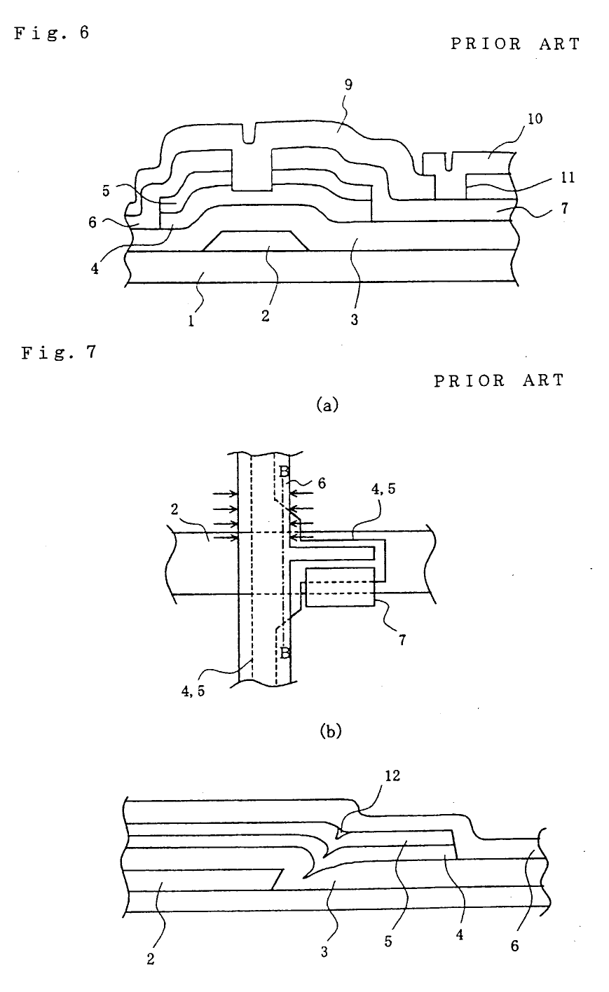

Although, in the foregoing first embodiment, the bends 8a are provided on both sides of the pattern of the gate wiring 2 as shown in FIG. 1 in the region where the gate wiring 2 and the source wiring 6 are intersected, it is also preferable that concaves 8b, 8c are provided on both sides of the pattern of the gate wiring in the region where the gate wiring 2 and the source wiring 6 are intersected, as shown in FIG. 2 or FIG. 3.

A recess 8b rectangular in section is shown in FIG. 2, and a concave 8c V-shaped in section is shown in FIG. 3. However, shape of the recesses is not limited to the rectangular or V-shape.

The remaining construction and a manufacturing method are the same as in the foregoing first embodiment, and further description thereof is omitted.

In this second embodiment, the same advantages as in the foregoing first embodiment can be obtained and, furthermore, variation in width of the gate wiring 2 is small as compared with the first embodiment, thereby enabling influence on capacity with the other electrode or wiring to be smaller.

Embodiment 3.

Although the concaves 8b, 8c are provided on both sides of the pattern of the gate wiring 2 as shown in FIG. 2 or FIG. 3 in the region where the gate wiring 2 and the source wiring 6 are intersected, it is also preferable that convexes 8d, 8e are provided on both sides of the pattern of the gate wiring 2 in the region where the gate wiring 2 and the source wiring 6 intersected, as shown in FIG. 4 or FIG. 5.

A square-shaped convex 8d is shown in FIG. 4, and a V-shaped convex 8e is shown in FIG. 5. However, shape of the convexity is not limited to the square-shape or V-shape.

The remaining construction and manufacturing method are the same as in the foregoing first embodiment, and further description thereof is omitted.

In this third embodiment, the same advantages as in the second embodiment can be obtained and, furthermore, a wiring resistance of the gate wiring 2 can be made smaller as compared with the second embodiment.

Additionally, in the mentioned first, second and third embodiments, protrusion length of the bends 8a or the convexes is to be approximately the same as the maximum gate wiring width on one side of the pattern; and a inward length of the concaves is to be ⅓ the maximum gate wiring width on one side of the pattern. Further, the maximum width of the concaves and convexes is to be ½ width of the source wiring, which intersects with the gate wiring.

What is claimed is:

1. A liquid crystal display comprising:
a plurality of scan lines formed on a transparent insulating substrate;
a plurality of signal lines formed in a direction of intersecting with said scan lines via an insulating layer; and
a switching element that is supplied with signals from said scan lines and said signal lines, and applies voltage to a display electrode;
wherein said scan lines have at least one bend on both sides of a pattern in a region where said scan lines intersect with said signal lines.

2. The liquid crystal display according to claim 1, wherein each of said scan lines has a concave on both sides of the pattern in a region where said scan lines intersect with said signal lines.

3. The liquid crystal display according to claim 1, wherein each of said scan line has a convex on both sides of the pattern in a region where said scan lines intersect with said signal lines.

4. The liquid crystal display according to claim 2 or claim 3, wherein said concaves and said convexes are rectangular or V-shaped in section.
